(19) United States
(12) Patent Application Publication
(10) Pub. No.: US 2025/0147267 A1
(43) Pub. Date: May 8, 2025

(54) DRIVING MECHANISM

(71) Applicant: TDK TAIWAN CORP., Taoyuan City (TW)

(72) Inventors: Kai-Po FAN, Taoyuan City (TW); Kun-Shih LIN, Taoyuan City (TW); Wei-Jhe SHEN, Taoyuan City (TW); Chen-Hung CHAO, Taoyuan City (TW); De Shiang CHEN, Taoyuan City (TW); Sin-Jhong SONG, Taoyuan City (TW)

(21) Appl. No.: 18/938,911

(22) Filed: Nov. 6, 2024

(30) Foreign Application Priority Data
Nov. 8, 2023 (CN) 202311481683.2

(51) Int. Cl. G02B 7/08; G02B 27/64

(52) U.S. Cl. CPC G02B 7/08; G02B 27/646

(57) ABSTRACT

A driving mechanism for moving an optical element is provided. The driving mechanism includes a fixed part, a movable part, and a driving assembly. The movable part is movably connected to the fixed part for holding the optical element. The driving assembly is configured for moving the movable part relative to the fixed part.

### CROSS REFERENCE TO RELATED APPLICATIONS

This Application claims priority of China Patent Application No. 202311481683.2, filed on Nov. 8, 2023, the entirety of which is incorporated by reference herein.

### BACKGROUND OF THE INVENTION

### Field of the Invention

The present invention relates to a driving mechanism, and, in particular, to a driving mechanism for moving an optical element.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

In some electronic devices, several coils and magnets corresponding to them are used to adjust the focus of the lens. However, miniaturization of these electronic devices may increase the difficulty of mechanical design, and it may also lead to low reliability and a low driving force for moving the lens. Addressing the aforementioned problems has become a challenge.

### BRIEF SUMMARY OF THE INVENTION

An embodiment of the present invention provides a driving mechanism for moving an optical element that has an optical axis. The driving mechanism includes a fixed part, a movable part, and a driving assembly. The movable part is movably connected to the fixed part for holding the optical element. The driving assembly is configured for moving the movable part relative to the fixed part.

In some embodiments, the driving mechanism further includes a quadrilateral upper resilient element, wherein the fixed part includes a housing and a base connected to each other, the upper resilient element connects the housing to the movable part, and a plurality of slots are formed at a corner of the upper resilient element.

In some embodiments, the housing forms a depressed structure that is depressed toward the upper resilient element and connected to the slots of the upper resilient element.

In some embodiments, the driving mechanism further includes an upper resilient element, wherein the fixed part includes a housing and a base connected to each other, and the upper resilient element connects the housing to the movable part, wherein the movable part forms a recess, and the upper resilient element forms an opening communicating with the recess.

In some embodiments, the movable part further forms a protrusion located in the recess.

In some embodiments, the driving mechanism further includes a lower resilient element, wherein the fixed part includes a housing and a base connected to each other, and the lower resilient element connects the movable part to the base, wherein the lower resilient element forms a positioning hole, and the movable part forms a nub extending into the positioning hole.

In some embodiments, the driving mechanism further includes a lower resilient element, wherein the fixed part includes a housing and a base connected to each other, and the lower resilient element connects the movable part to the base, wherein the lower resilient element forms an opening, and the movable part forms a depression that communicates with the opening.

In some embodiments, the driving mechanism further includes a lower resilient element and a wire, wherein the fixed part includes a housing and a base connected to each other, and the lower resilient element connects the movable part to the base, wherein the driving assembly includes a coil disposed on the movable part and a magnetic element disposed on the inner side of the housing, the movable part has a bobbin, the wire is connected between the coil and the bobbin, and the lower resilient element has a recessed portion close to the bobbin and electrically connected to the wire on the bobbin.

In some embodiments, the driving mechanism further includes a lower resilient element and a conductive member, wherein the fixed part includes a housing and a base connected to each other, and the lower resilient element connects the movable part to the base, wherein the conductive member is embedded in the base, and an end portion of the conductive member is exposed to a top side of the base for electrical connection to the lower resilient element.

In some embodiments, the base has a quadrilateral shape, and the end portion of the conductive member is located at a corner of the base.

In some embodiments, the lower resilient element forms an elongated through hole that has a long axis angled relative to a side of the base, and the through hole at least partially overlaps the end portion in a direction parallel to the optical axis.

In some embodiments, the driving mechanism further includes a circuit assembly, wherein the fixed part includes a housing and a base connected to each other, and the base has a rib portion, wherein the circuit assembly is affixed to the outer side of the rib portion.

In some embodiments, the base further has a bottom surface, a left restricting surface, and a right restricting surface adjacent to the rib portion, and the circuit assembly abuts the bottom surface and one of the left and right restricting surfaces.

In some embodiments, the circuit assembly includes a circuit board.

In some embodiments, the driving mechanism further includes a magnet disposed on the movable part and a magnetic field sensor disposed on the circuit assembly for detecting the position of the magnet.

In some embodiments, the driving mechanism further includes a circuit assembly and a conductive member, wherein the fixed part includes a housing and a base connected to each other, the circuit assembly is disposed on the base, and the conductive member is embedded in the base and electrically connected to the circuit assembly.

In some embodiments, an end of the conductive member forms an L-shaped structure.

In some embodiments, the conductive member is embedded in the base by insert molding.

In some embodiments, the base has a rib portion, and the circuit assembly is affixed to the outer side of the rib portion, wherein a groove and a sloped surface are formed on the inner side of the rib portion, and the sloped surface is located in the groove and adjacent to a corner of the L-shaped structure.

In some embodiments, the movable part has a quadrilateral shape, and a cavity is formed on the top side of the movable part and located close to a corner of the movable part.

### BRIEF DESCRIPTION OF THE DRAWINGS

The present invention can be more fully understood by reading the subsequent detailed description and examples with references made to the accompanying drawings, wherein:

FIG. 1 shows an exploded view of a driving mechanism 100 in accordance with an embodiment of the invention.

FIG. 2 shows another exploded view of the driving mechanism 100 in FIG. 1.

FIG. 3 shows a perspective diagram of the driving mechanism 100 in FIGS. 1 and 2.

FIG. 4 shows another perspective diagram of the driving mechanism 100 in FIGS. 1 and 2.

FIG. 5 is an exploded view of the upper resilient element FS and the housing H before assembly.

FIG. 6 is a perspective diagram of the upper resilient element FS and the housing H after assembly.

FIG. 7 is a perspective diagram of the holder LH and the coils C disposed on the holder LH.

FIG. 8 is a partial enlarged perspective view showing the opening FS2 of the upper resilient element FS in communication with the recess R of the holder LH.

FIG. 9 is another perspective diagram of the holder LH and the coils C disposed on the holder LH.

FIG. 10 is a perspective diagram showing the lower resilient elements BS, the coils C, and the holder LH after assembly.

FIG. 11 is a partial enlarged perspective view showing the lower resilient element BS affixed to the bottom side of the holder LH.

FIG. 12 is a perspective diagram of the circuit assembly F and the base B after assembly.

FIG. 13 is a perspective diagram showing the lower resilient elements BS mounted on the base B.

FIG. 14 is a perspective diagram showing the coils C and the holder LH received in the base B.

FIG. 15 is a partial perspective view showing the laser beam transmitted in the direction D when performing laser welding.

FIG. 16 is an exploded diagram of the circuit assembly F and the base B.

FIG. 17 is a cross-sectional view taken along line A1-A2 in FIG. 3.

FIG. 18 is a cross-sectional view taken along line A3-A4 in FIG. 3.

FIG. 19 is a partial enlarged view showing the rib portion B1 formed on the base B.

FIG. 20 is a cross-sectional view showing the positioning pin S in contact with the conductive member P.

### DETAILED DESCRIPTION OF THE INVENTION

The making and using of the embodiments of the driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

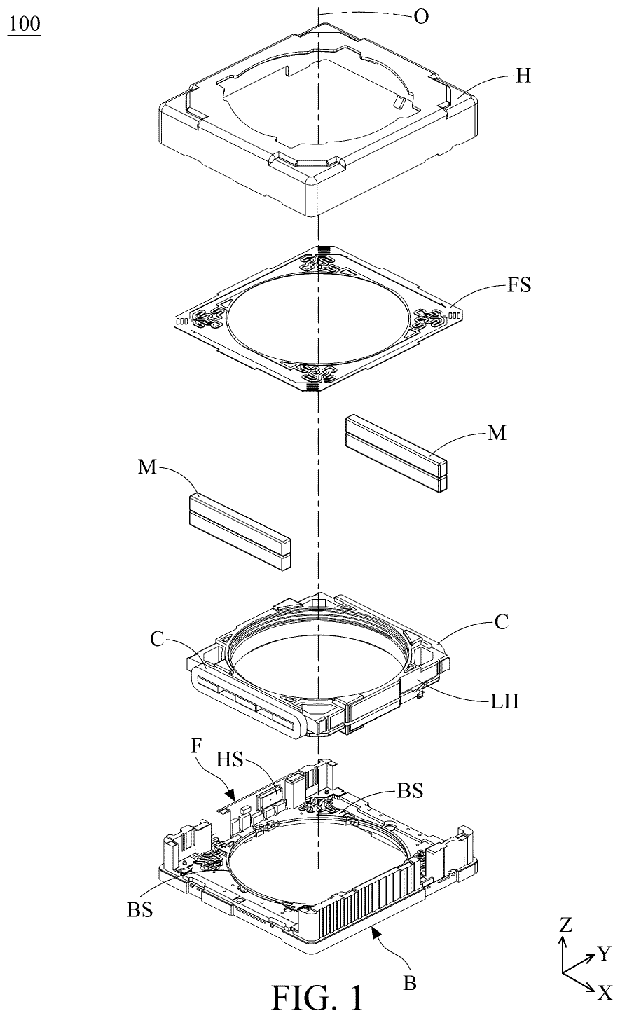

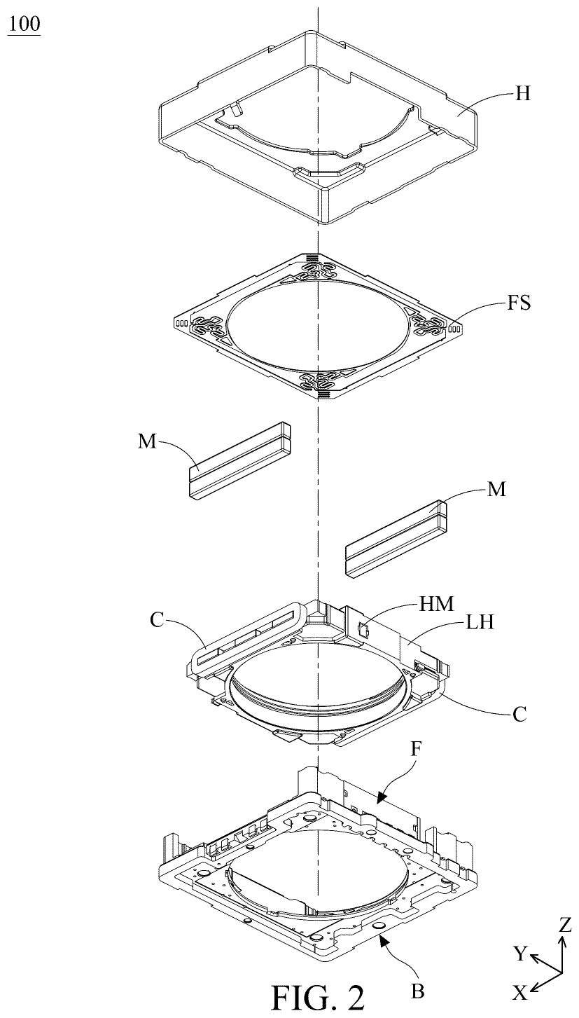

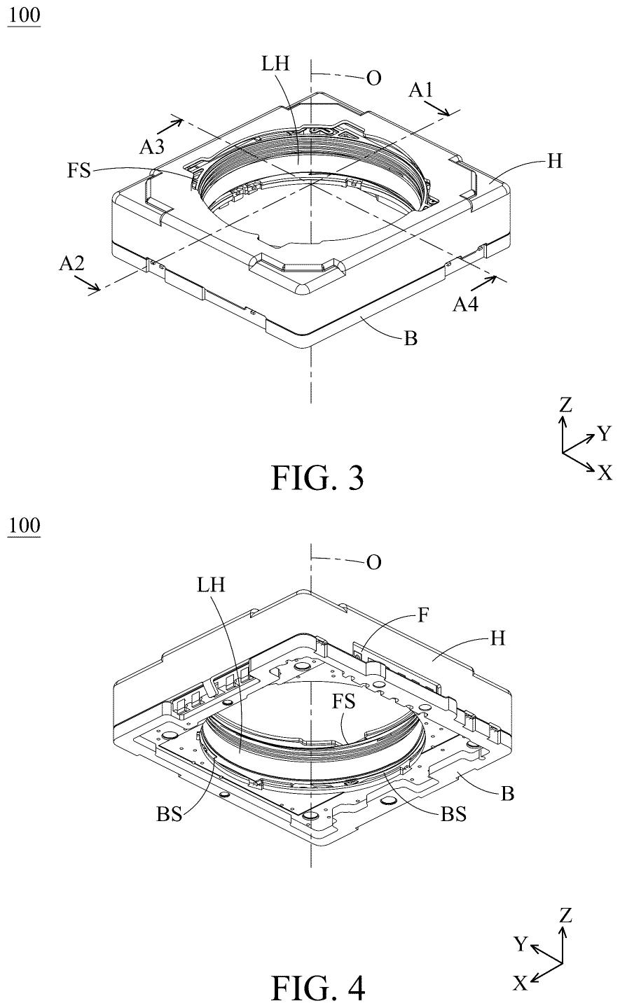

FIG. 1 shows an exploded view of a driving mechanism 100 in accordance with an embodiment of the invention. FIG. 2 shows another exploded view of the driving mechanism 100 in FIG. 1. FIG. 3 shows a perspective diagram of the driving mechanism 100 in FIGS. 1 and 2. FIG. 4 shows another perspective diagram of the driving mechanism 100 in FIGS. 1 and 2.

Referring to FIGS. 1-4, the driving mechanism 100 in this embodiment is a Voice Coil Motor (VCM) which may be disposed in a cell phone or other portable electronic device for driving an optical element (e.g. optical lens) to move, thereby achieving the function of auto-focusing (AF) or Optical Image Stabilization (OIS).

The driving mechanism 100 primarily comprises a housing H, a plastic base B, a circuit assembly F, a holder LH, an upper resilient element FS, at least a lower resilient element BS, at least a magnetic element M, and at least a coil C. In this embodiment, the housing H has a hollow structure affixed to the base B. The housing H and the base B form a fixed part of the driving mechanism 100, and the circuit assembly F is affixed to a side of the base B.

Additionally, the holder LH is movably received in the housing H, and an optical element (not shown) is affixed in the holder LH. The holder LH forms a movable part that is movable relative to the fixed part (the housing H and the base B).

The holder LH is connected to the housing H and the base B via the upper and lower resilient elements FS and BS (e.g. metal sheet springs), so that the holder LH can be suspended within the driving mechanism 100. With the configuration as described above, external light can enter the driving mechanism 100 substantially along the optical axis O (parallel to the Z axis) of the optical element, and light can propagate through the optical element to an image sensor (not shown) below the base B to form a digital image.

It should be noted that two oval-shaped coils C are disposed on opposite sides of the holder LH. Moreover. Two magnetic elements M (e.g. magnets) are disposed on the inner sides of the housing H and located corresponding to the coils C. The coils C and the magnetic elements M constitute a driving assembly for impelling the movable part (the holder LH) relative to the fixed part (the housing H and the base B).

When a current signal is applied to the coils C, an electromagnetic force can be generated by the coils C and the magnets M, so that the holder LH and the optical element received therein can be driven to move relative to the fixed part (the housing H and the base B) along the optical axis O (Z direction). Hence, the function of auto-focusing (AF) or Optical Image Stabilization (OIS) can be achieved.

FIGS. 1 and 2 further show that a magnetic field sensor HS is disposed on the circuit assembly F, and a magnet HM is disposed on a side of the movable part LH and located corresponding to the magnetic field sensor HS (FIG. 2). It should be noted that the magnetic field sensor HS may be a Hall effect sensor, MR sensor, or Fluxgate sensor to detect the position variation of the magnet HM for detecting the position variation of the magnet HM, so that the displacement of the holder LH relative to the fixed part (the housing H and the base B) can be determined.

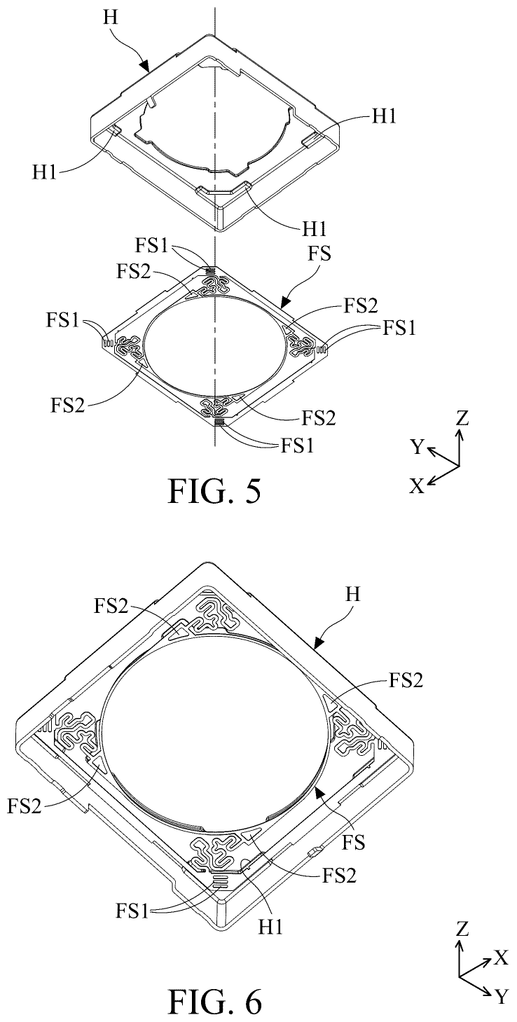

FIG. 5 is an exploded view of the upper resilient element FS and the housing H before assembly. FIG. 6 is a perspective diagram of the upper resilient element FS and the housing H after assembly.

As shown in FIGS. 5 and 6, both of the upper resilient element FS and the housing H have a quadrilateral shape. Specifically, four depressed structures H1 are formed at the corners of the housing H and depressed in the −Z direction. Moreover, a plurality of slots FS1 are formed at the four corners of the upper resilient element FS.

It can be seen in FIG. 6 that the depressed structures H1 are depressed toward the upper resilient element FS, and the slots FS1 of the upper resilient element FS are connected to the depressed structures H1 after assembly. With the slots FS1 formed at the corners of the upper resilient element FS, the housing H and the upper resilient element FS can be firmly affixed to each other by welding or soldering.

Still referring to FIGS. 5 and 6, the upper resilient element FS forms at least an opening FS2 for receiving the glue so that the holder LH (movable part) and the upper resilient element FS can be adhered to each other.

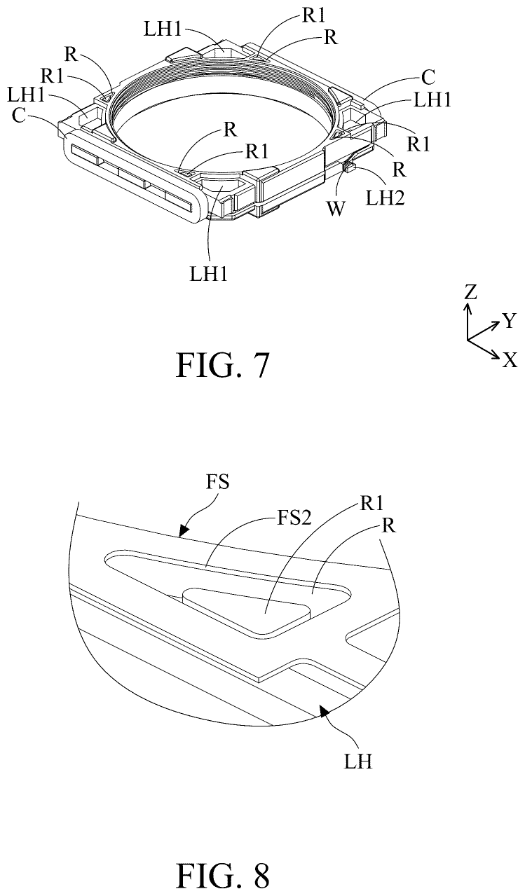

FIG. 7 is a perspective diagram of the holder LH and the coils C disposed on the holder LH. FIG. 8 is a partial enlarged perspective view showing the opening FS2 of the upper resilient element FS in communication with the recess R of the holder LH.

Referring to FIG. 7, at least a cavity LH1 is formed on the top side and close to the corner of the holder LH. Thus, structural deficiency of the holder LH due to non-uniform thickness distribution in the molding process can be avoided.

It can be seen in FIGS. 7 and 8 that at least a recess R is formed the top side of the holder LH, and a protrusion R1 is formed in the recess R. Specifically, the opening FS2 of the upper resilient element FS is aligned to and in communication with the recess R of the holder LH.

During assembly of the driving mechanism 100, the glue can be applied into the recess R on the top side of the holder LH through the opening FS2 of the upper resilient element FS. With the protrusion R1 formed in the recess R, the adhesion area between the holder LH and the glue can be increased, thereby enhancing the connection strength of the holder LH and the upper resilient element FS.

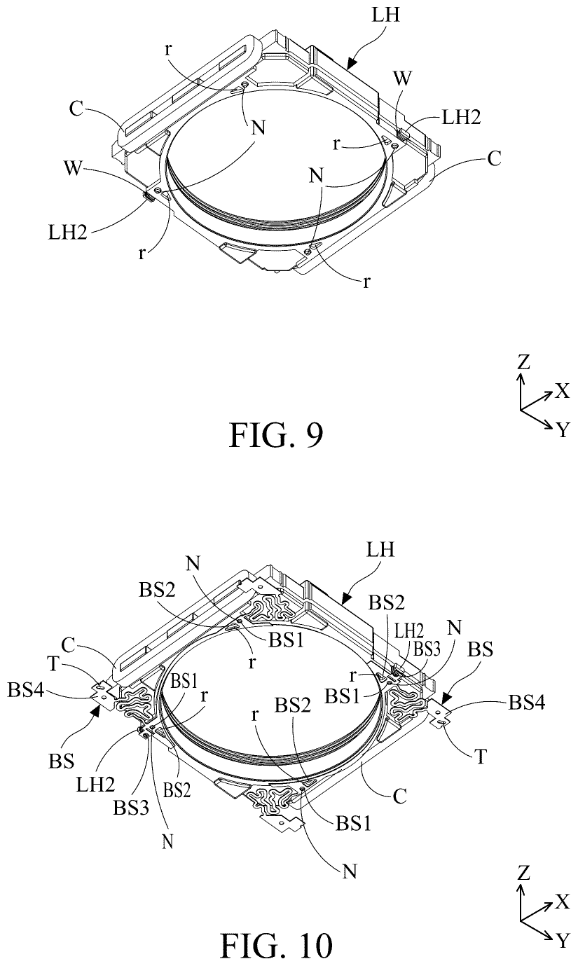

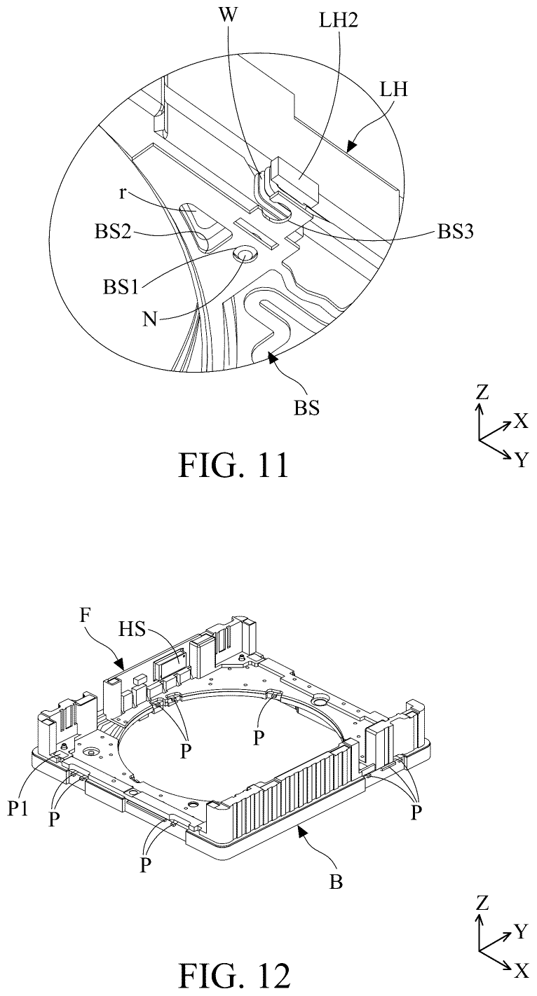

FIG. 9 is another perspective diagram of the holder LH and the coils C disposed on the holder LH. FIG. 10 is a perspective diagram showing the lower resilient elements BS, the coils C, and the holder LH after assembly. FIG. 11 is a partial enlarged perspective view showing the lower resilient element BS affixed to the bottom side of the holder LH.

Referring to FIG. 9, a depression r and a nub are formed on the bottom side of the holder LH. Additionally, two bobbins LH2 are formed on the opposite sides of the holder LH, and two wires W connect the coils C to the bobbins LF2. In this embodiment, the ends of the two wires are respectively wound on the bobbins LH2.

As shown in FIGS. 10 and 11, each lower resilient element BS has a positioning hole BS1, an opening BS2, and a round recessed portion BS3. During assembly, the nub B extends through the positioning hole BS1 of the lower resilient element BS (FIG. 11), whereby the lower resilient element BS is secured in a predetermined position on the bottom side of the holder LH. Additionally, the opening BS2 of the lower resilient element BS is aligned to and communicates with the depression r of the holder LH, and the bobbins LH2 are located close to the recessed portion BS3 of the lower resilient elements BS. During assembly, the solder can be disposed in the recessed portions BS3, and it can flow to connect the lower resilient elements BS with the wires W wound on the bobbins LH2. Hence, the coils C can be electrically connected to the wires W on the bobbins LH2

Moreover, FIGS. 10 and 11 further show that a conductive pad BS4 is formed at the end of the lower resilient element BS. Specifically, the conductive pad BS4 forms an elongated through hole T, and the conductive member P can be connected to the conductive pad BS4 by laser welding.

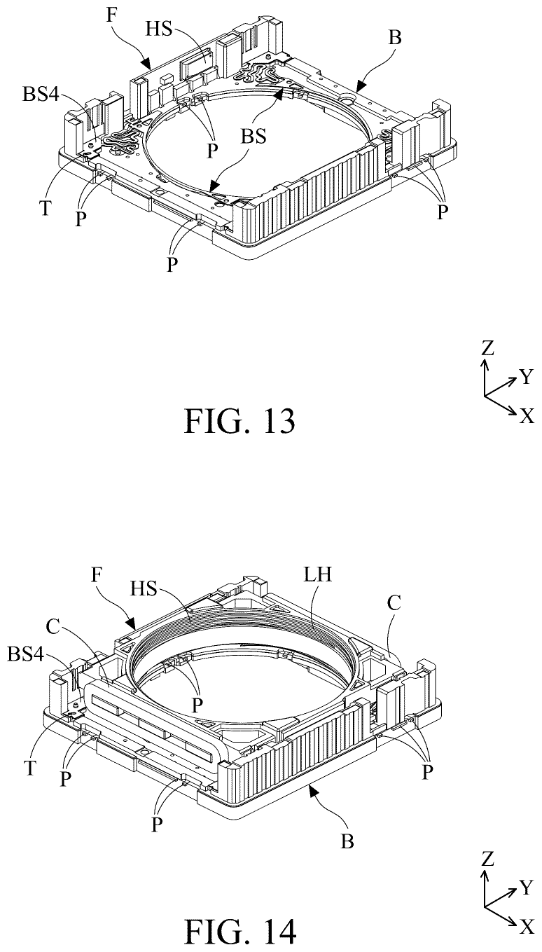

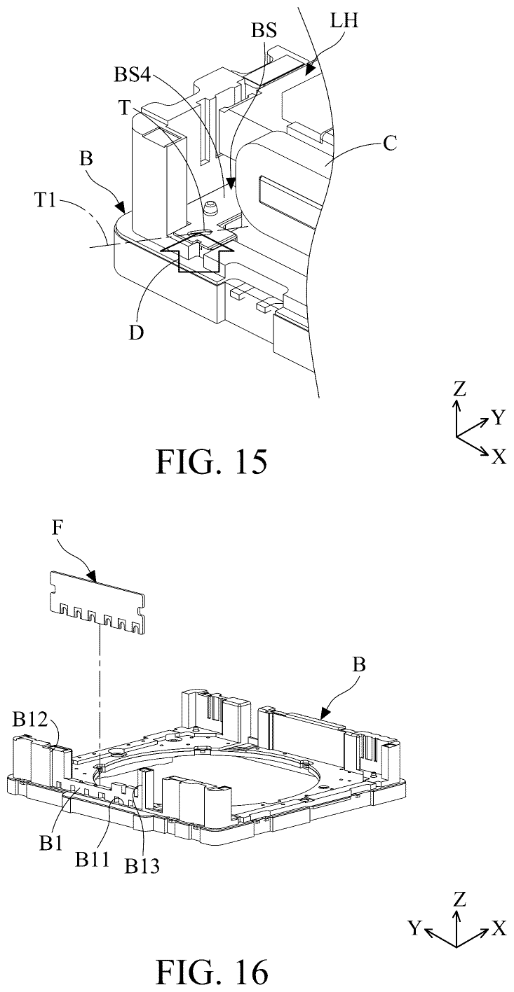

FIG. 12 is a perspective diagram of the circuit assembly F and the base B after assembly. FIG. 13 is a perspective diagram showing the lower resilient elements BS mounted on the base B. FIG. 14 is a perspective diagram showing the coils C and the holder LH received in the base B. FIG. 15 is a partial perspective view showing the laser beam transmitted in the direction D when performing laser welding.

Referring to FIG. 12, several metal conductive members P are embedded in the plastic base B by inset molding. At least one of the conductive members P has an end portion P1 exposed to the top side of the base B and located at a corner of the quadrilateral base B.

Furthermore, as shown in FIGS. 13 and 14, the lower resilient elements BS are disposed on the top side of the base B and connected to the holder LH, whereby the holder LH can be movably received in the base B. In this embodiment, the conductive pad BS4 of the lower resilient element BS is affixed to the end portion P1 of the conductive member P by laser welding.

It should be noted that the laser beam is transmitted in the direction D when performing laser welding, as shown in FIG. 15, so that the laser beam would not be obstructed by the holder LH or the base B. Here, the direction D is substantially perpendicular to the long axis T1 of the elongated through hole T, wherein the long axis T1 is angled with respect to the four sides of the quadrilateral base B. That is, the long axis T1 of the through hole T has an inclined angle relative to the X and Y axes.

In this embodiment, the end portion P1 of the conductive member P and the through hole T of the lower resilient element BS at least partially overlap when viewed along the optical axis O (Z direction).

FIG. 16 is an exploded diagram of the circuit assembly F and the base B. Referring to FIG. 16, a rib portion B1 is formed on a side of the base B. Moreover, a bottom surface B11, a left restricting surface B12, and a right restricting surface B13 are formed on the outer side of the rib portion B1. During assembly, the circuit assembly F (e.g. circuit board) may be adhered to the rib portion B1 and abut the bottom surface B11 and either one of the left and right restricting surfaces B12 and B13. Hence, the circuit assembly F can be precisely positioned in a predetermined position, thereby achieving high accuracy of the magnetic field sensor HS when detecting the magnet HM.

It should be noted that the left and right restricting surfaces B12 and B13 are parallel to the optical axis O (Z direction). The bottom surface B11 is perpendicular to the left and right restricting surfaces B12 and B13. The bottom surface B11, the left restricting surface B12, and the right restricting surface B13 are located adjacent to the rib portion B1.

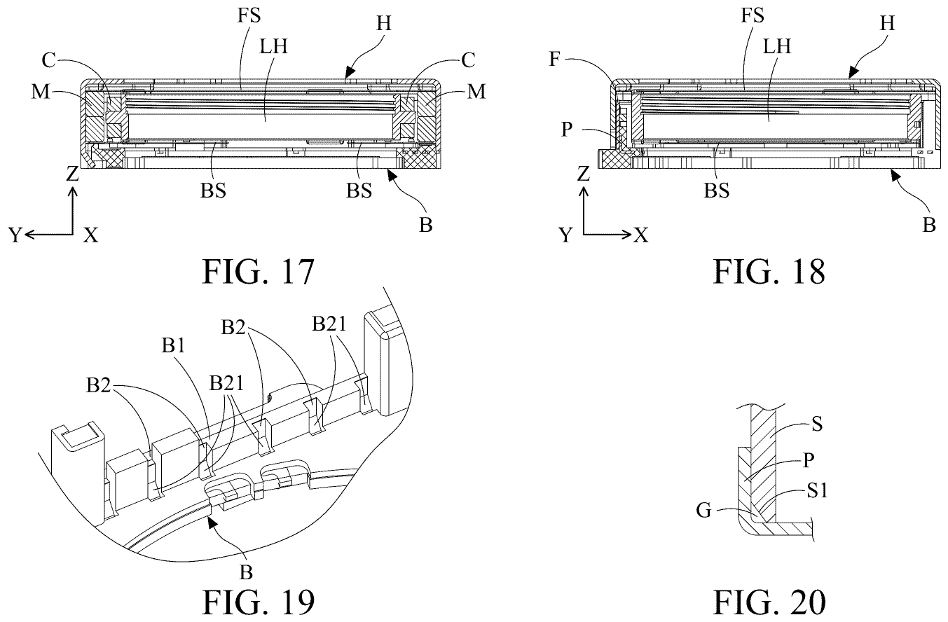

FIG. 17 is a cross-sectional view taken along line A1-A2 in FIG. 3. FIG. 18 is a cross-sectional view taken along line A3-A4 in FIG. 3.

Referring to FIG. 17, the magnetic elements M are affixed on the inner side of the housing H and located corresponding to the coils C on the holder LH. When a current signal is applied to the coils C, an electromagnetic force can be generated by the coils C and the magnets M, so that the holder LH and the optical element received therein can be driven to move relative to the fixed part (the housing H and the base B) along the optical axis O (Z direction). Hence, the function of auto-focusing (AF) or Optical Image Stabilization (OIS) can be achieved.

As shown in FIG. 18, at least a conductive member P is embedded in the base B. The end of the conductive member P forms an L-shaped structure for electrical connection to the circuit assembly F.

FIG. 19 is a partial enlarged view showing the rib portion B1 formed on the base B. FIG. 20 is a cross-sectional view showing the positioning pin S in contact with the conductive member P.

Referring to FIG. 19, at least one groove B2 and at least one sloped surface B21 are formed on the inner side of the rib portion B1. The sloped surface B21 is located in the groove B2 and adjacent to the corner of the L-shaped structure of the conductive member P.

It should be noted that the groove B2 and the sloped surface B21 are defined by the positioning pin S, as shown in FIG. 20. During the plastic injection molding process for forming the base B, the positioning pin S is in contact with the conductive member P to retain the L-shaped structure, and the space G (FIG. 20) between the conductive member P and the chamfered surface S1 of the positioning pin S is filled with plastic material, thus forming the groove B2 and the sloped surface B21 (FIG. 19).

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A driving mechanism for moving an optical element that has an optical axis, the driving mechanism comprising:
a fixed part;
a movable part, movably connected to the fixed part for holding the optical element; and
a driving assembly, configured for moving the movable part relative to the fixed part.

2. The driving mechanism as claimed in claim 1, further comprising a quadrilateral upper resilient element, wherein the fixed part includes a housing and a base connected to each other, the upper resilient element connects the housing to the movable part, and a plurality of slots are formed at a corner of the upper resilient element.

3. The driving mechanism as claimed in claim 2, wherein the housing forms a depressed structure that is depressed toward the upper resilient element and connected to the slots of the upper resilient element.

4. The driving mechanism as claimed in claim 1, further comprising an upper resilient element, wherein the fixed part includes a housing and a base connected to each other, and the upper resilient element connects the housing to the movable part, wherein the movable part forms a recess, and the upper resilient element forms an opening communicating with the recess.

5. The driving mechanism as claimed in claim 4, wherein the movable part further forms a protrusion located in the recess.

6. The driving mechanism as claimed in claim 1, further comprising a lower resilient element, wherein the fixed part includes a housing and a base connected to each other, and the lower resilient element connects the movable part to the base, wherein the lower resilient element forms a positioning hole, and the movable part forms a nub extending into the positioning hole.

7. The driving mechanism as claimed in claim 1, further comprising a lower resilient element, wherein the fixed part includes a housing and a base connected to each other, and the lower resilient element connects the movable part to the base, wherein the lower resilient element forms an opening, and the movable part forms a depression that communicates with the opening.

8. The driving mechanism as claimed in claim 1, further comprising a lower resilient element and a wire, wherein the fixed part includes a housing and a base connected to each other, and the lower resilient element connects the movable part to the base, wherein the driving assembly comprises a coil disposed on the movable part and a magnetic element disposed on the inner side of the housing, the movable part has a bobbin, the wire is connected between the coil and the bobbin, and the lower resilient element has a recessed portion close to the bobbin and electrically connected to the wire on the bobbin.

9. The driving mechanism as claimed in claim 1, further comprising a lower resilient element and a conductive member, wherein the fixed part includes a housing and a base connected to each other, and the lower resilient element connects the movable part to the base, wherein the conductive member is embedded in the base, and an end portion of the conductive member is exposed to a top side of the base for electrical connection to the lower resilient element.

10. The driving mechanism as claimed in claim 9, wherein the base has a quadrilateral shape, and the end portion of the conductive member is located at a corner of the base.

11. The driving mechanism as claimed in claim 10, wherein the lower resilient element forms an elongated through hole that has a long axis angled relative to a side of the base, and the through hole at least partially overlaps the end portion in a direction parallel to the optical axis.

12. The driving mechanism as claimed in claim 1, further comprising a circuit assembly, wherein the fixed part includes a housing and a base connected to each other, and the base has a rib portion, wherein the circuit assembly is affixed to the outer side of the rib portion.

13. The driving mechanism as claimed in claim 12, wherein the base further has a bottom surface, a left restricting surface, and a right restricting surface adjacent to the rib portion, and the circuit assembly abuts the bottom surface and one of the left and right restricting surfaces.

14. The driving mechanism as claimed in claim 13, wherein the circuit assembly comprises a circuit board.

15. The driving mechanism as claimed in claim 14, further comprising a magnet disposed on the movable part and a magnetic field sensor disposed on the circuit assembly for detecting the position of the magnet.

16. The driving mechanism as claimed in claim 1, further comprising a circuit assembly and a conductive member, wherein the fixed part includes a housing and a base connected to each other, the circuit assembly is disposed on the base, and the conductive member is embedded in the base and electrically connected to the circuit assembly.

17. The driving mechanism as claimed in claim 16, wherein an end of the conductive member forms an L-shaped structure.

18. The driving mechanism as claimed in claim 17, wherein the conductive member is embedded in the base by insert molding.

19. The driving mechanism as claimed in claim 18, wherein the base has a rib portion, and the circuit assembly is affixed to the outer side of the rib portion, wherein a groove and a sloped surface are formed on the inner side of the rib portion, and the sloped surface is located in the groove and adjacent to a corner of the L-shaped structure.

20. The driving mechanism as claimed in claim 1, wherein the movable part has a quadrilateral shape, and a cavity is formed on the top side of the movable part and located close to a corner of the movable part.
